(19) United States
(12) Patent Application Publication
(10) Pub. No.: US 2025/0258644 A1
(43) Pub. Date: Aug. 14, 2025

(54) WEARABLE DEVICE FOR PERFORMING CONTINUOUS BEAMFORMING ON AT LEAST ONE OBJECT, AND METHOD OF CONTROLLING THE WEARABLE DEVICE

(71) Applicant: SAMSUNG ELECTRONICS CO., LTD., Suwon-si (KR)

(72) Inventors: Jonghwan KIM, Suwon-si (KR); Changtaek KANG, Suwon-si (KR); Jaeha PARK, Suwon-si (KR); Seongkwan YANG, Suwon-si (KR); Hochul HWANG, Suwon-si (KR)

(21) Appl. No.: 19/197,931

(22) Filed: May 2, 2025

Related U.S. Application Data
(63) Continuation of application No. PCT/KR2023/016270, filed on Oct. 19, 2023.

(30) Foreign Application Priority Data
Nov. 2, 2022 (KR) 10-2022-0144156
Nov. 15, 2022 (KR) 10-2022-0152241

(51) Int. Cl. G06F 3/16; G06F 3/01; H04R 1/32

(52) U.S. Cl. CPC G06F 3/167; G06F 3/011; G06F 3/165; H04R 1/326; H04R 2499/15

(57) ABSTRACT

Disclosed are a wearable device for performing continuous beamforming on at least one object, and a method of controlling the wearable device. The wearable device includes: a plurality of microphones; a display module; at least one speaker; at least one processor. The wearable device may perform beamforming on at least one object located around a user wearing the wearable device, by using at least one microphone; output, on the basis of performing the beamforming, a notification corresponding to the at least one object through at least one of the at least one speaker or the display module; identify movement of the wearable device rotating to face an object among a plurality of objects; and highlight and output, on the basis of identifying the movement, through at least one of the at least one speaker or the display module, the notification while maintaining the beamforming on the at least one object.

This application is a continuation application, claiming priority under § 365(c), of International Application No. PCT/KR2023/016270, filed on Oct. 19, 2023, which claims priority to Korean Patent Application No. 10-2022-0144156, filed on Nov. 2, 2022, and Korean Patent Application No. 10-2022-0152241, filed on Nov. 15, 2022, with the Korean Intellectual Property Office, the disclosures of which are incorporated by reference herein in their entireties.

### BACKGROUND

### Field

The disclosure relates to a wearable device for performing continuous beamforming with respect to at least one object, and a method of controlling the wearable device.

### Description of the Related Art

Various services and additional functions provided through an electronic device, for example, a mobile electronic device, such as AR glasses or a virtual reality providing device, have been increased. Communication service providers or electronic device manufacturers have been competitively developing electronic devices for providing various functions and differentiation from other businesses to improve effective values of such electronic device and satisfy various desires of users. Therefore, various functions provided through electronic devices have become increasingly advanced.

In a case in which software processing is performed to remove noise from a voice signal input through an array of microphones included in a wearable device (e.g., AR glasses configured to provide augmented reality), a beam may be generated from the array of microphones in a particular direction in accordance with the software processing. As such, beamforming technology is used to generate a beam using the array of a plurality of microphones to direct the beam in the desired direction from the plurality of microphones. In a case in which directivity is established in the direction of sound signals generated from a specific object through beamforming technology, the energy corresponding to sound signals input from directions outside the beam is attenuated, and sound signals from the direction of interest may be selectively acquired.

In a case in which a content is provided through the wearable device (e.g., AR glasses configured to provide augmented reality), the user receiving the content provided through the wearable device may have difficulty identifying hazards, such as an external object (e.g., a vehicle) approaching from the periphery. Even during the function or operation of recognizing sound generated by such an external object and performing beamforming with respect to the external object to amplify the sound generated by the external object and providing the amplified sound to the user, if the user turns toward the external object (e.g., shifting of gaze), the beamforming may not be maintained for the external object, and amplified sound may not be delivered to the user through the wearable device.

### SUMMARY

An embodiment of the disclosure may provide a wearable device which, even in a case in which after an external object (e.g., a vehicle) is identified, a user wearing the wearable device rotates (e.g., shifting of gaze) toward the external object, may perform continuously perform beamforming with respect to the external object such that object-adapted beamforming may be performed.

An embodiment of the disclosure may provide the wearable device which, in a case in which after an external object (e.g., a vehicle) is identified, a user wearing the wearable device rotates (e.g., shifting of gaze) toward the external object, may amplify and output a notification corresponding to the external object (e.g., a sound signal generated by the external object) to facilitate identification of the hazard by the user wearing the wearable device.

An embodiment of the disclosure may provide the wearable device which may activate at least one microphone corresponding (e.g., relatively close to the external object) to the external object (e.g., a vehicle) to optimize (e.g., minimize) the current consumption of the wearable device.

An embodiment of the disclosure may provide an operation method of a wearable device, by which even in a case in which after an external object (e.g., a vehicle) is identified, a user wearing the wearable device rotates (e.g., shifting of gaze) toward the external object, beamforming may be continuously performed on the external object such that object-adapted beamforming may be performed.

An embodiment of the disclosure may provide the operation method of the wearable device by which, in a case in which after an external object (e.g., a vehicle) is identified, a user wearing the wearable device rotates (e.g., shifting of gaze) toward the external object, a notification corresponding to the external object (e.g., a sound signal generated by the external object) may be amplified and output to facilitate identification of the hazard by the user wearing the wearable device.

A wearable device according to an embodiment of the disclosure may include a plurality of microphones, a display module, at least one speaker, at least one processor, and memory storing instructions that, when executed by the at least one processor individually or collectively, cause the wearable device to perform beamforming with respect to at least one object located around a user wearing the wearable device by using at least one microphone among the plurality of microphones, output, based on performing the beamforming, a notification corresponding to the at least one object through at least one of the at least one speaker or the display module, identify movement of the user (or wearable device worn by the user) in which the wearable device is rotating to face an object among a plurality of objects including the at least one object, and highlight and output, based on identifying the movement, the notification corresponding to the at least one object through at least one of the at least one speaker or the display module while maintaining the beamforming with respect to the at least one object.

An operation method of a wearable device according to an embodiment of the disclosure may include an operation of performing beamforming with respect to at least one object located around a user wearing the wearable device by using at least one microphone among a plurality of microphones, an operation of outputting, based on performing the beamforming, a notification corresponding to the at least one object through the at least one speaker of the wearable device and/or the display module of the wearable device, an operation of identifying movement of the user (or wearable device being worn by the user) in which the wearable device is rotating to face an object among a plurality of objects including the at least one object, and an operation of highlighting and outputting, based on identifying the movement, the notification corresponding to the at least one object through at least one of the at least one speaker or the display module while maintaining the beamforming with respect to the at least one object.

An embodiment of the disclosure may provide a wearable device which, even in a case in which after an external object (e.g., a vehicle) is identified, a user wearing the wearable device rotates (e.g., shifting of gaze) toward the external object, may continuously perform beamforming with respect to the external object such that object-adapted beamforming may be performed.

An embodiment of the disclosure may provide the wearable device which, in a case in which after an external object (e.g., a vehicle) is identified, a user wearing the wearable device rotates (e.g., shifting of gaze) toward the external object, may amplify and output a notification corresponding to the external object (e.g., a sound signal generated by the external object) to facilitate identification of the hazard by the user wearing the wearable device.

An embodiment of the disclosure may provide the wearable device which may activate at least one microphone corresponding (e.g., relatively close to the external object) to the external object (e.g., a vehicle) to optimize (e.g., minimize) the current consumption of the wearable device.

The effects according to various embodiments of the document are not limited to the effects described herein, and it is obvious to those skilled in the art that various effects are inherent in the document.

### BRIEF DESCRIPTION OF THE DRAWINGS

FIG. 1 is a block view illustrating an electronic device in a network environment according to various embodiments of the disclosure.

FIG. 2A is a perspective view illustrating a wearable device (e.g., an electronic device) according to an embodiment of the disclosure.

FIG. 2B is a perspective view illustrating an inner configuration of a wearable device (e.g., an electronic device) according to an embodiment of the disclosure.

FIG. 2C is an exploded perspective view illustrating a wearable device (e.g. an electronic device) according to an embodiment of the disclosure.

FIGS. 3A and 3B are views illustrating a front surface and a rear surface of a wearable device (e.g., an electronic device) according to an embodiment.

FIG. 4 is a view illustrating a function or operation of, in a case in which a user wearing a wearable device rotates (e.g., shifting of gaze), highlighting and outputting a notification with respect to at least one external object while maintaining beamforming with respect to the at least one external object (e.g., a vehicle) according to an embodiment of the disclosure.

FIG. 5 is a view illustrating a function or operation of identifying a plurality of external objects located around a user wearing a wearable device and performing beamforming with respect to each of the identified a plurality of external objects according to an embodiment of the disclosure.

FIG. 6 is a view illustrating a function or operation of providing a notification with respect to a plurality of external objects through a wearable device according to an embodiment of the disclosure.

FIG. 7 is a view illustrating a function or operation of, in a case in which a user wearing a wearable device rotates (e.g., shifting of gaze) toward one of a plurality of external objects, maintaining beamforming with respect to the one external object according to an embodiment of the disclosure.

FIG. 8A is a view illustrating a function or operation of highlighting a notification with respect to one external object and providing same to a user according to an embodiment of the disclosure.

FIGS. 8B and 8C are views illustrating various types of notifications with respect to a plurality of external objects according to an embodiment of the disclosure.

FIG. 9 is a view illustrating a function or operation of, in a case in which a user wearing a wearable device rotates (e.g., shifting of gaze) toward one of a plurality of external objects, changing at least some of microphones which are performing beamforming to another microphone so as to maintain beamforming with respect to one object according to an embodiment of the disclosure.

FIG. 10 is a view illustrating a function or operation of performing beamforming with respect to a specific external object (e.g., a vehicle) by using some of a plurality of microphones according to an embodiment of the disclosure.

FIG. 11 is a view illustrating a function or operation of, in a case in which a user wearing a wearable device rotates by a specific angle (e.g., 0), changing at least some of microphones which are performing beamforming to another microphone so as to maintain beamforming being performed with respect to a specific external object (e.g., a vehicle) according to an embodiment of the disclosure.

FIGS. 12A, 12B, and 12C are views illustrating a function or operation of, in a case in which a user wearing a wearable device rotates by a specific angle (e.g., θ), maintaining directivity of a beam according to an embodiment of the disclosure.

FIG. 13 is a view illustrating a function or operation of, in a case in which a user wearing a wearable device rotates (e.g., shifting of gaze) toward a specific external object (e.g., a vehicle), switching to a video see through (VST) mode according to an embodiment of the disclosure.

FIG. 14 is a view illustrating a function or operation of determining a type of a notification, based on whether a sound signal generated from an external object located around a user wearing a wearable device is a sound signal included in a designated risk group, and providing the notification to the user according to the determined type of the notification according to an embodiment of the disclosure.

FIGS. 15A and 15B are views illustrating a type 1 notification and a type 2 notification according to an embodiment of the disclosure.

FIG. 16 is a view illustrating a function or operation of, in a case in which at least one external object is identified when a wearable device and an external electronic device are operatively connected, outputting a content sound together with a sound generated from at least one external object through the external electronic device according to an embodiment of the disclosure.

### DETAILED DESCRIPTION

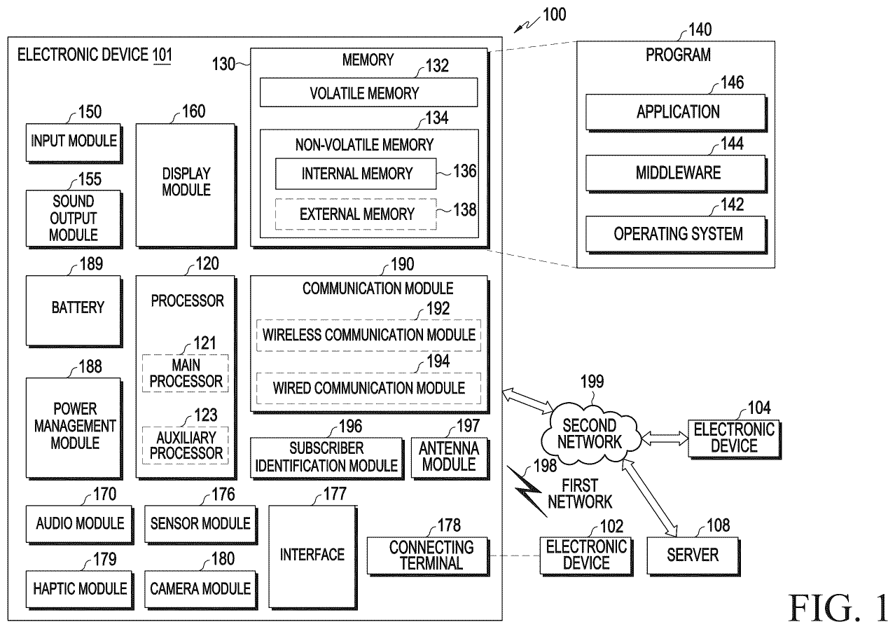

FIG. 1 is a block view illustrating an electronic device 101 in a network environment according to various embodiments of the disclosure.

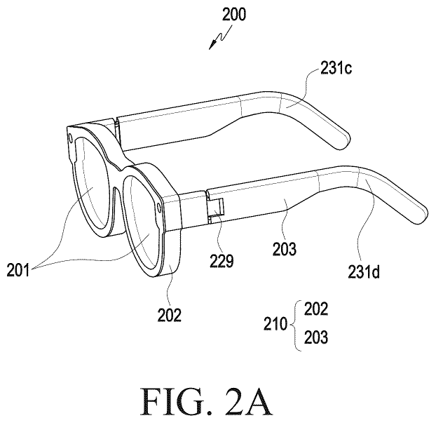

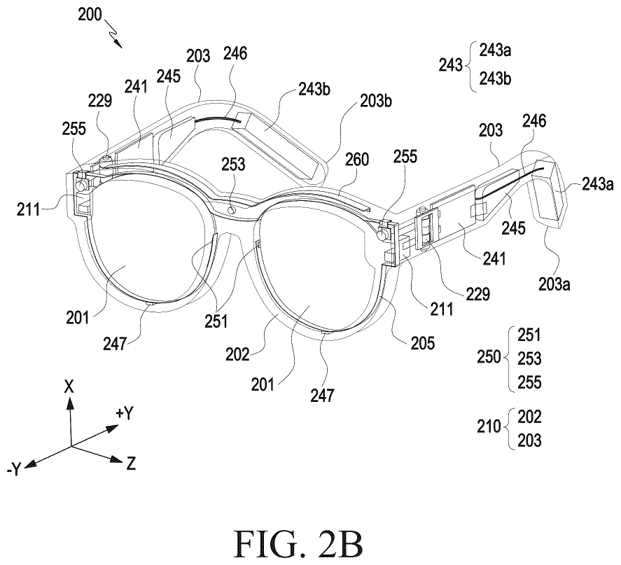

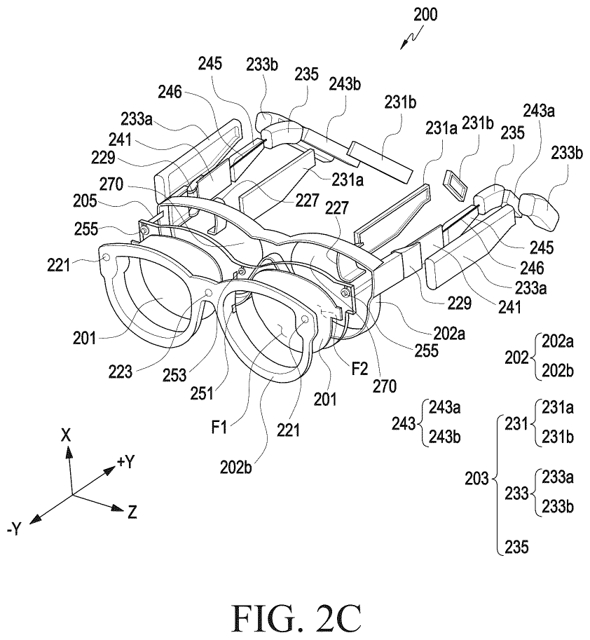

FIG. 2A is a perspective view illustrating a wearable device 200 according to an embodiment of the disclosure.

FIG. 2B is a perspective view illustrating an inner configuration of a wearable device 200 according to an embodiment of the disclosure.

FIG. 2C is an exploded perspective view illustrating a wearable device 200 according to an embodiment of the disclosure.

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. In an example in which the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

FIG. 2A is a perspective view illustrating a wearable device 200 according to an embodiment of the disclosure.

Referring to FIG. 2A, the wearable device 200 may include a glasses-type electronic device and a user may visually recognize an object or environment therearound while wearing the wearable device 200. For example, the wearable device 200 may include a head mounting device (HMD) or smart glasses which may directly provide an image in front of the user's eye. The configuration of the wearable device 200 of FIG. 2A may be entirely or partially identical to that of the electronic device 101 of FIG. 1.

According to various embodiments, the wearable device 200 may include a housing 210 configuring an exterior of the wearable device 200. The housing 210 may provide a space in which components of the wearable device 200 may be arranged. For example, the housing 210 may include a lens frame 202 and at least one wearing member 203.

According to various embodiments, the wearable device 200 may include at least one display member 201 capable of providing visual information to a user. For example, the display member 201 may include a module to which a lens or a second window member, a display, a waveguide, and/or a touch circuit is mounted. According to an embodiment, the display member 201 may be configured to be transparent or translucent. According to an embodiment, the display member 201 may include glass formed by a translucent material or a window member of which light transmittance may be adjusted by adjusting a coloring density. According to an embodiment, a pair of display members 201 may be provided and arranged to correspond to a right eye and a left eye of a user, respectively, while the wearable device 200 is worn on the user's body.

According to various embodiments, the lens frame 202 may receive at least a portion of the display member 201. For example, the lens frame 202 may surround at least a portion of an edge of the display member 201. According to another embodiment, the lens frame 202 may locate at least one of the display member 201 to correspond to a user's eye. According to an embodiment, the lens frame 202 may include a rim of a general glasses structure. According to an embodiment, the lens frame 202 may include at least one closed curved line for surrounding the display member 201.

According to various embodiments, the wearing member 203 may extend from the lens frame 202. For example, the wearing member 203 may extend from an end portion of the lens frame 202 and may be supported by or located on the user's body (e.g., the ear) together with the lens frame 202. According to an embodiment, the wearing member 203 may be rotatably coupled to the lens frame 202 through a hinge structure 229. According to an embodiment, the wearing member 203 may include an inner lateral surface 231c configured to face a user's body and an outer lateral surface 231d opposite to the inner lateral surface.

According to various embodiments, the wearable device 200 may include a hinge structure 229 configured to allow the wearing member 203 to be foldable with respect to the lens frame 202. The hinge structure 229 may be disposed between the lens frame 202 and the wearing member 203. In a state of not wearing the wearable device 200, the user may carry or store the wearable device by folding the wearing member 203 such that a portion thereof partially overlaps the lens frame 202.

FIG. 2B is a perspective view illustrating an internal configuration of a wearable device according to an embodiment of the disclosure. FIG. 2C is an exploded perspective view of a wearable device according to an embodiment of the disclosure.

Referring to FIGS. 2B and 2C, the wearable device 200 may include components (e.g., at least one circuit board 241 (e.g., a printed circuit board (PCB), a printed board assembly (PBA), a flexible PCB (FPCB), or a rigid-flexible PCB (RFPCB)), at least one battery 243, at least one speaker module 245, at least one power transfer structure 246, and a camera module 250) received in the housing 210. The configuration of the housing 210 in FIG. 2B may be entirely or partially identical to the configuration of the display member 201, the lens frame 202, the wearing member 203, and the hinge structure 229 of FIG. 2A.

According to various embodiments, the wearable device 200 may acquire and/or recognize a visual image related to an object or environment in a direction the user views or the wearable device 200 is directed (e.g., the −Y direction) by using the camera module 250 (e.g., the camera module 180 in FIG. 1) and may be provided with information on the object or environment from an external electronic device (e.g., the electronic device 102 or 104 or the server 108 in FIG. 1) through a network (e.g., the first network 198 or the second network 199 in FIG. 1). In an embodiment, the wearable device 200 may provide the provided information on the object or environment to the user in an audio or visual form. The wearable device 200 may provide the provided information on the object or environment to the user in a visual form by using a display module (e.g., the display module 160 in FIG. 1) through the display member 201. For example, as the wearable device 200 realizes the information on the object or environment in a visual form to be combined with a real image of a surrounding environment of the user, the wearable device 200 may implement the augmented reality.

According to various embodiments, the display member 201 may include a first surface F1 facing a direction (e.g., the −Y direction) in which light is incident and a second surface F2 facing a direction (e.g., the +Y direction) opposite to the first surface F1. In a state in which the user wears the wearable device 200, light incident through the first surface F1 or at least a portion of an image may pass through the second surface F2 of the display member 201 disposed to face the right eye and/or the left eye of the user to be incident to the right eye and/or the left eye of the user.

According to various embodiments, the lens frame 202 may include two or more frames. For example, the lens frame 202 may include a first frame 202a and a second frame 202b. According to an embodiment, in a case in which the user wears the wearable device 200, the first frame 202a may correspond to a frame of a portion facing the user's face and the second frame 202b may correspond to a portion of the lens frame 202 spaced apart in a direction of the user's gaze (e.g., the −Y direction) with respect to the first frame 202a.

According to various embodiments, a light output module 211 may provide an image and/or moving image to the user. For example, the light output module 211 may include a display panel (not illustrated) capable of outputting an image and a lens (not illustrated) corresponding to the user's eye and guiding the image to the display member 201. For example, the user may acquire an image output from the display panel of the light output module 211 through the lens of the light output module 211. According to various embodiments, the light output module 211 may include a device configured to display various information. For example, the light output module 211 may include at least one of a liquid crystal display (LCD), a digital mirror display device (digital mirror device, DMD), a liquid crystal on silicon (LCoS), an organic light-emitting diode (OLED), or a micro light emitting diode (micro LED). According to an embodiment, in a case in which the light output module 211 and/or the display member 201 includes one of a LCD, a DMD, or a LCoS, the wearable device 200 may include a light source configured to emit light to a display area of the light output module 211 and/or the display member 201. According to an embodiment, in a case in which the light output module 211 and/or the display member 201 includes one of an OLED or a micro-LED, the wearable device 200 may provide a virtual image to the user without including a separate light source.

According to various embodiments, at least a portion of the light output module 211 may be disposed in the housing 210. For example, the light output module 211 may be disposed in the wearing member 203 or the lens frame 202 to correspond to the user's right and left eyes, respectively. According to an embodiment, the light output module 211 may be connected to the display member 201 and may provide an image to the user through the display member 201.

According to various embodiments, a circuit board 241 may include components for driving the wearable device 200. For example, the circuit board 241 may include at least one integrated circuit chip and at least one of the processor 120, the memory 130, the power management module 188, or the communication module 190 of FIG. 1 may be provided on the integrated chip. According to an embodiment, the circuit board 241 may be disposed in the wearing member 203 of the housing 210. According to an embodiment, the circuit board 241 may be electrically connected to the battery 243 through the power transfer structure 246. According to an embodiment, the circuit board 241 may be connected to the flexible printed circuit board 205 and may transfer an electrical signal to electronic components (e.g., the light output module 211, the camera module 250, and a light-emitting part) of the electronic device through the flexible printed circuit board 205. According to an embodiment, the circuit board 241 may correspond to a circuit board including an interposer.

According to various embodiments, the flexible printed circuit board 205 may extend from the circuit board 241 to an inside of the lens frame 202 via the hinge structure 229 and may be disposed on at least a portion of a circumference of the display member 201 inside the lens frame 202.

According to various embodiments, the battery 243 (e.g., the battery 189 in FIG. 1) may be electrically connected to components (e.g., the light output module 211, the circuit board 241, the speaker module 245, the microphone module 247, and the camera module 250) of the wearable device 200 and may provide power to the components of the wearable device 200.

According to various embodiments, at least a portion of the battery 243 may be disposed in the wearing member 203. According to an embodiment, the battery 243 may be disposed at an end portion 203a or 203b of the wearing member 203. For example, the battery 243 may include a first battery 243a disposed at a first end portion 203a and a second battery 243b disposed at a second end portion 203b of the wearing member 203.

According to various embodiments, the speaker module 245 (e.g., the audio module 170 or the sound output module 155 in FIG. 1) may convert an electrical signal into a sound. At least a portion of the speaker module 245 may be disposed in the wearing member 203 of the housing 210. According to an embodiment, the speaker module 245 may be disposed in the wearing member 203 to correspond to the user's ear. For example, the speaker module 245 may be disposed between the circuit board 241 and the battery 243.

According to various embodiments, the power transfer structure 246 may transfer power of the battery 243 to an electronic component (e.g., the light output module 211) of the wearable device 200. For example, the power transfer structure 246 may be electrically connected to the battery 243 and/or the circuit board 241, and the circuit board 241 may transfer power received through the power transfer structure 246 to the light output module 211. According to an embodiment, the power transfer structure 246 may be connected to the circuit board 241 via the speaker module 245. In an example in which viewing the wearable device 200 from the lateral surface (e.g., the Z-axis direction), the power transfer structure 246 may at least partially overlap the speaker module 245.

According to various embodiments, the power transfer structure 246 may correspond to a configuration capable of transferring power. For example, the power transfer structure 246 may include a flexible printed circuit board or a wire. For example, the wire may include a plurality of cables (not illustrated). In various embodiments, a form of the power transfer structure 246 may be variously changed according to the number and/or type of cables.

According to various embodiments, the microphone module 247 (e.g., the input module 150 and/or the audio module 170 in FIG. 1) may convert a sound into an electrical signal. According to an embodiment, the microphone module 247 may be disposed on at least a portion of the lens frame 202. For example, at least one microphone module 247 may be disposed on a lower end (e.g., a direction facing the −X axis) and/or an upper end (e.g., a direction facing the X axis) of the wearable device 200. According to various embodiments, the wearable device 200 may recognize a user's voice more clearly by using voice information (e.g., a sound) acquired by at least one microphone module 247. For example, the wearable device 200 may distinguish voice information and peripheral noise based on the acquired voice information and/or additional information (e.g., a low-frequency vibration of the user's skin and bones). For example, the wearable device 200 may clearly recognize the user's voice and perform a function (e.g., noise canceling) for reducing peripheral noise. The microphone module 247 according to an embodiment of the disclosure may include a plurality of microphone modules 247 configured to perform beamforming. The microphone module 247 according to an embodiment of the disclosure may include an omnidirectional or directional microphone.

According to various embodiments, the camera module 250 may capture a still image and/or video. The camera module 250 may include at least one of a lens, at least one image sensor, an image signal processor, or a flash. According to an embodiment, the camera module 250 may be disposed within the lens frame 202 and around the display member 201.

According to various embodiments, the camera module 250 may include at least one first camera module 251. According to an embodiment, the first camera module 251 may capture the user's eye (e.g., a pupil) or a trajectory of a gaze. For example, the first camera module 251 may capture a reflection pattern of light emitted by the light-emitting part to the user's eye. For example, the light-emitting part 330 may emit light in an infrared band for tracking a trajectory of a gaze by using the first camera module 251. For example, the light-emitting part 330 may include an IR LED. According to an embodiment, a processor (e.g., the processor 120 in FIG. 1) may adjust a location of a virtual image such that the virtual image projected to the display member 201 corresponds to a direction in which the user's eye gazes. According to an embodiment, the first camera module 251 may include a global shutter (GS) type camera and a trajectory of the user's eyes or gaze by using may be tracked by using a plurality of first camera modules 251 of the same standard and performance.

According to various embodiments, the first camera module 251 may periodically or aperiodically transmit information (e.g., trajectory information) on tracking of a trajectory of the user's eye or gaze to the processor (e.g., the processor 120 in FIG. 1). According to an embodiment, when detecting that the user's gaze is changed (e.g., moving more than a reference value in a state in which the head does not move) based on the trajectory information, the first camera module 251 may transmit the trajectory information to the processor.

According to various embodiments, the camera module 250 may include a second camera module 253. According to an embodiment, the second camera module 253 may capture an image of the outside. According to an embodiment, the second camera module 253 may include a global shutter or rolling shutter (RS) type camera. According to an embodiment, the second camera module 253 may capture an image of the outside through a second optical hole 223 disposed through the second frame 202b. For example, the second camera module 253 may include a high-resolution color camera and correspond to a high resolution (HP) or photo video (PV) camera. In some aspects, the second camera module 253 may provide an auto focus (AF) and image stabilization function (optical image stabilizer (OIS)).

According to various embodiments, the wearable device 200 may include a flash (not illustrated) located adjacent to the second camera module 253. For example, the flash (not illustrated) may provide light for increasing brightness (e.g., illuminance) of a periphery of the wearable device 200 when the second camera module 253 acquires an external image and may reduce image acquisition difficulties due to dark environments, incorporation of various light sources, and/or reflections of light.

According to various embodiments, the camera module 250 may include at least one third camera module 255. According to an embodiment, the third camera module 255 may capture an operation of the user through the first optical hole 221 disposed through the lens frame 202. For example, the third camera module 255 may capture a user's gesture (e.g., a hand motion). The third camera module 255 and/or the first optical hole 221 may be disposed at opposite lateral ends of the lens frame 202 (e.g., the second frame 202b), for example, at opposite ends of the lens frame 202 (e.g., the second frame 202b) in the X direction, respectively. According to an embodiment, the third camera module 255 may include a global shutter (GS) type camera. For example, the third camera module 255 may correspond to a camera for supporting 3 degrees of freedom (3DoF) or 6DoF and 360-degree space (e.g., omnidirectional) location recognition, and/or movement recognition. According to an embodiment, the third camera module 255 may perform a moving path tracking function (simultaneous localization and mapping (SLAM)) and a user movement recognition function by using a plurality of global shutter-type cameras having an identical specification and performance as a stereo camera. According to an embodiment, the third camera module 255 may include an infrared (IR) camera (e.g., a time of flight (TOF) camera or structured light camera). For example, the IR camera may operate as at least a portion of a sensor module (e.g., the sensor module 176 in FIG. 1) for detecting a distance to an object.

According to an embodiment, at least one of the first camera module 251 or the third camera module 255 may be replaced with a sensor module (e.g., the sensor module 176 in FIG. 1) (e.g., a Lidar sensor). For example, the sensor module may include at least one of a vertical cavity surface emitting laser (VCSEL), an infrared sensor, and/or a photodiode. For example, the photodiode may include a positive intrinsic negative (PIN) photodiode or an avalanche photo diode (APD). The photodiode may be referred to as a photo detector or a photo sensor.

According to an embodiment, at least one of the first camera module 251, the second camera module 253, or the third camera module 255 may include a plurality of camera modules (not illustrated). For example, the second camera module 253 may include a plurality of lenses (e.g., wide-angle and telephoto lenses) and image sensors and may be disposed on a surface (e.g., a surface facing the −Y axis) of the wearable device 200. For example, the wearable device 200 may include a plurality of camera modules having different properties (e.g., an angle of view) or functions and control to change angles of view of camera modules based on a user's selection and/or trajectory information. For example, at least one of the plurality of camera modules may correspond to a wide-angle camera and at least another one may correspond to a telephoto camera.

According to various embodiments, the processor (e.g., the processor 120 in FIG. 1) may determine movement of the wearable device 200 and/or movement of the user based on information of the wearable device 200 acquired by using at least one of a gesture sensor, a gyro sensor, or an acceleration sensor of the sensor module (e.g., the sensor module 176 in FIG. 1) and an operation (e.g., approach of the user to the wearable device 200) of the user acquired by using the first camera module 251. According to an embodiment, in addition to the sensors described herein, the wearable device 200 may include a magnetic (geomagnetic) sensor that may measure a direction using a magnetic field and magnetic line of force, and/or a Hall sensor that may acquire movement information (e.g., a movement direction or movement distance) using a strength of a magnetic field. For example, the processor may determine movement of the wearable device 200 and/or movement of the user based on information acquired from a magnetic (geomagnetic) sensor and/or a Hall sensor.

According to various embodiments (not illustrated), the wearable device 200 may perform an input function (e.g., a touch and/or pressure detection function) which allows interaction with the user. For example, a component (e.g., a touch sensor and/or pressure sensor) configured to perform a touch and/or pressure detection function may be disposed on at least a portion of the wearing member 203. The wearable device 200 may control a virtual image output through the display member 201 based on information acquired through the components. For example, a sensor related to a touch and/or pressure detection function may be configured in various types, such as a resistive type, a capacitive type, an electro-magnetic type (EM), or an optical type. According to an embodiment, the component configured to perform the touch and/or pressure detection function may be entirely or partially identical to the input module 150 in FIG. 1.

According to various embodiments, the wearable device 200 may include a reinforcement member 260 disposed in an internal space of the lens frame 202 and formed to have a rigidity higher than that of the lens frame 202.

According to various embodiments, the wearable device 200 may include a lens structure 270. The lens structure 270 may refract at least a portion of light. For example, the lens structure 270 may correspond to a prescription lens having refractive power. According to an embodiment, the lens structure 270 may be disposed in a rear side (e.g., the +Y direction) of a second window member of the display member 201. For example, the lens structure 270 may be disposed between the display member 201 and the user's eye. For example, the lens structure 270 may face the display member.

According to various embodiments, the housing 210 may include a hinge cover 227 capable of covering a portion of the hinge structure 229. Another portion of the hinge structure 229 may be received between or covered by an inner case 231 and an outer case 233 which will be described herein.

According to various embodiments, the wearing member 203 may include the inner case 231 and the outer case 233. The inner case 231 may correspond to, for example, a case configured to face the user's body or come into direct contact with the user's body and may be manufactured by a material with low thermal conductivity such as a resin. According to an embodiment, the inner case 231 may include an inner lateral surface (e.g., the inner lateral surface 231c in FIG. 2A) facing the user's body. The outer case 233 may include, for example, a material (e.g., a metallic material) capable of at least partially transferring heat and may be coupled to face the inner case 231. According to an embodiment, the outer case 233 may include an outer surface (e.g., the outer surface 231d in FIG. 2A) opposite to the internal surface 231c. In an embodiment, at least one of the circuit board 241 or the speaker module 245 may be received in a space separated from the battery 243 within the wearing member 203. In the described embodiment, the inner case 231 may include a first case 231a including the circuit board 241 or the speaker module 245 and a second case 231b for receiving the battery 243, and the outer case 233 may include a third case 233a coupled to face the first case 231a and a fourth case 233d coupled to face the second case 231b. For example, the first case 231a and the third case 233a may be coupled (hereinafter, a “first case part 231a or third case part 233a”) to receive the circuit board 241 and/or the speaker module 245, and the second case 231b and the fourth case 233b may be coupled (hereinafter, a “second case part 231b or fourth case part 233b”) to receive the battery 243.

According to various embodiments, the first case 231a and the third case part 233a may be rotatably coupled to the lens frame 202 through the hinge structure 229, and the second case part 231b and the fourth case part 233b may respectively be connected or mounted to end portions of the first case part 231a and the third case part 233a through the connection member 235. In some embodiments, a portion of the connection member 235, which comes in contact with the user's body, may be manufactured of a material having a low heat conductivity, for example, an elastic material such as silicone or polyurethane, and a portion not in contact with the user's body may be manufacture of a material (e.g., a metallic material) having a high conductivity. For example, in a case in which heat is generated from the circuit board 241 or the battery 243, the connection member 235 may block the heat from being transferred to the portion coming in contact with the user's body and disperse or dissipate the heat through the portion not in contact with the user's body. According to an embodiment, the portion of the connection member 235, which is configured to come in contact with the user's body, may be interpreted as a portion of the inner case 231, and the portion of the connection member 235, which is not in contact with the user's body may be interpreted as a portion of the outer case 233. According to an embodiment (not illustrated), the first case 231a and the second case 231b may be integrally formed without the connection member 235, and the third case 233a and the fourth case 233b may be integrally formed without the connection member 235. According to various embodiments, other components (e.g., the antenna module 197 in FIG. 1) may be further included in addition to the aforementioned components, and information on the object or environment may be provided from an external electronic device (e.g., the external electronic device 102 of 104 or the server 108 in FIG. 1) through the network (e.g., the first network 198 or the second network 199 in FIG. 1) by using the communication module 190.

Only the wearable devices 200 is illustrated and described in FIGS. 2A to 2C, but it is not limited thereto, and a portion of the configuration of the wearable device 200 illustrated in FIGS. 2A to 2C may be included in an electronic device, such as a smartphone or a tablet PC.

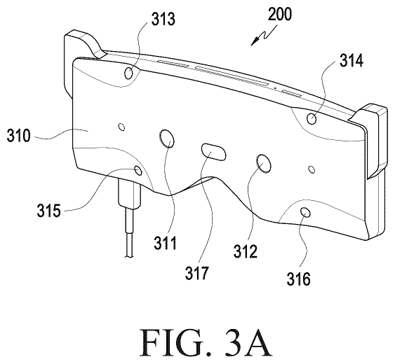

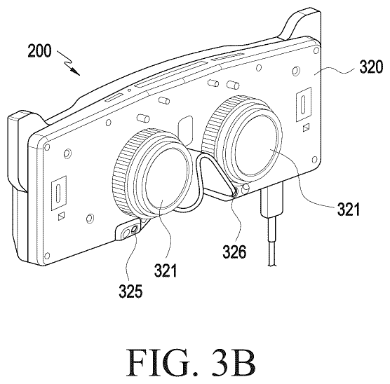

FIGS. 3A and 3B are views illustrating a front surface and a rear surface of a wearable electronic device 101 according to an embodiment.

Referring to FIGS. 3A and 3B, in an embodiment, a depth sensor 317 and/or camera modules 311, 312, 313, 314, 315, and 316 for acquiring information related to a peripheral environment of the wearable electronic device 101 may be arranged on a first surface 310 of a housing.

In an embodiment, the camera modules 311 and 312 may acquire an image related to a peripheral environment of the wearable electronic device.

In an embodiment, the camera modules 313, 314, 315, and 316 may acquire an image in a state where the wearable electronic device is worn by the user. An image acquired through the camera modules 313, 314, 315, and 316 may be used for simultaneous localization and mapping (SLAM), 6 degrees of freedom (6DoF), 3 degrees of freedom (3DoF), subject recognition, and/or tracking, and a user's hand may be recognized and/or tracked and used as an input to the wearable electronic device.

In an embodiment, the depth sensor 317 may be configured to transmit a signal and receive a signal reflected from a subject and may be used to identify a distance to an object, such as time of flight (TOF).

According to an embodiment, a face recognition camera module 325 or 326 and/or a display 321 (and/or a lens) may be arranged on a second surface 320 of the housing.

In an embodiment, the face recognition camera module 325 or 326 adjacent to the display may be used to recognize the user's face or may recognize and/or track both eyes of the user.

In an embodiment, the display 321 (and/or the lens) may be disposed on the second surface 320 of the wearable electronic device 101. In an embodiment, the wearable electronic device 101 may not include the camera modules 315 and 316 among a plurality of camera modules 313, 314, 315, and 316. Although not illustrated in FIGS. 3A and 3B, the wearable electronic device 101 may further include at least one of components illustrated in FIGS. 2A to 2C.

As described herein, the wearable electronic device 101 according to an embodiment may have a form factor to be mounted on the user's head. The wearable electronic device 101 may further include a strap and/or wearing member (e.g., the wearing member 203 in FIGS. 2A to 2C) for securing the wearable electronic device onto a user's body part. The wearable electronic device 101 may provide a user experience based on augmented reality, virtual reality, and/or mixed reality in a state of being mounted on the user head.

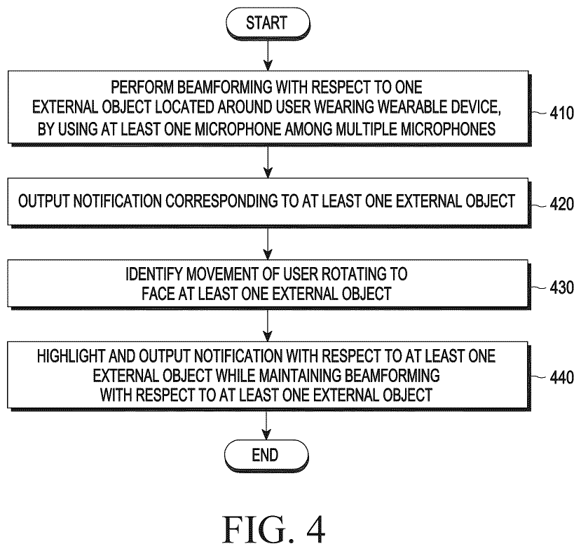

FIG. 4 is a view illustrating a function or operation of, in a case in which a user wearing a wearable device 200 rotates (e.g., shifting of gaze), highlighting and outputting a notification with respect to at least one external object (e.g., a vehicle 510) while maintaining beamforming with respect to the at least one external object (e.g., the vehicle 510) according to an embodiment of the disclosure.

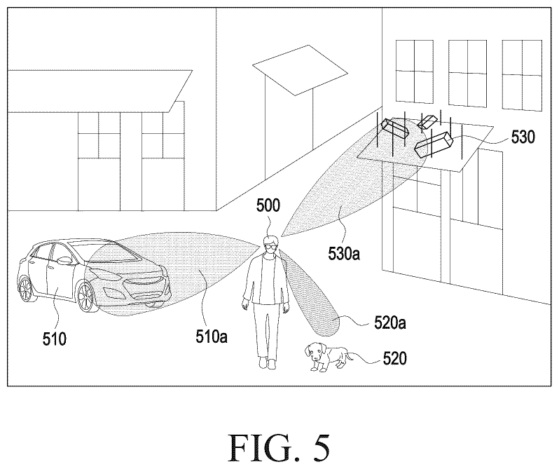

Referring to FIG. 4, the wearable device 200 (e.g., the electronic device 101 in FIG. 1) according to an embodiment of the disclosure, in operation 410, may perform beamforming with respect to at least one external object (e.g., the vehicle 510, an animal 520, or a falling object 530) located around the user 500 wearing the wearable device 200 by using at least one microphone (e.g., a first microphone 247a and a second microphone 247b) among a plurality of microphones (e.g., the microphone module 247). The wearable device 200 according to an embodiment of the disclosure may identify at least one external object (e.g., the vehicle 510, the animal 520, and/or the falling object 530) located around the user 500 wearing the wearable device 200 by analyzing (e.g., comparing a shape of an external object with a shape stored in the wearable device 200) an image captured by at least one camera (e.g., the second camera module 253) capable of capturing a periphery of the user 500 wearing the wearable device 200. Descriptions herein of an object located “around” the user 500 or the wearable device 200 may refer to the object being located within a predetermined distance or area with respect to the object. The predetermined distance or area may be a distance or area according to which the wearable device 200 is capable of detecting objects (e.g., using sensing devices or sensor modules of the wearable device 200 (for example, a camera, a microphone, or the like), or using wireless communication devices) in accordance with one or more embodiments of the present disclosure. In some aspects, descriptions of an object located “around” the user 500 or the wearable device 200 may refer objects which have been identified (e.g., as later described with reference to FIG. 5) by the wearable device 200.

According to an embodiment of the disclosure, the at least one external object (e.g., the vehicle 510, the animal 520, and/or the falling object 530) may have been designated by the user 500. For example, the wearable device 200 according to an embodiment of the disclosure may provide a user interface (e.g., a screen) including various types of objects to designate at least one external object (e.g., the vehicle 510, the animal 520, and/or the falling object 530). According to an embodiment of the disclosure, the wearable device 200, based on user input with respect to the user interface (e.g., a screen), may determine at least one external object (e.g., the vehicle 510, the animal 520, and/or the falling object 530) corresponding to an object to be identified. According to an embodiment of the disclosure, the wearable device 200, based on a sound signal generated from at least one external object (e.g., the vehicle 510, the animal 520, and/or the falling object 530), may identify at least one external object (e.g., the vehicle 510, the animal 520, and/or the falling object 530) (e.g., determine at least one external object as an object on which beamforming is to be performed). According to an embodiment of the disclosure, the wearable device 200 may compare the sound signal generated from the at least one external object (e.g., the vehicle 510, the animal 520, and/or the falling object 530) with a stored or learned sound signal. According to an embodiment of the disclosure, the wearable device 200 may determine a type of the external object (e.g., identify what external object is) by comparing the sound signals.

According to an embodiment of the disclosure, the wearable device 200, based a gaze of the user 500 identified through the camera module (e.g., the first camera module 251), may identify at least one external object (e.g., the vehicle 510, the animal 520, and/or the falling object 530). According to an embodiment of the disclosure, the wearable device 200, in a case in which the user 500 is gazing at a specific object for a designated time or more, may identify a type of the object which the user 500 is gazing at, based on an image captured by the camera module (e.g., the second camera module 253). According to an embodiment of the disclosure, the wearable device 200 may also determine the object which the user 500 is gazing for a designated time or more as an object on which beamforming is to be performed.

FIG. 5 is a view illustrating a function or operation of identifying a plurality of external objects (e.g., the vehicle 510, the animal 520, and/or the falling object 530) located around a user wearing the wearable device 200 and performing beamforming with respect to each of the identified a plurality of external objects (e.g., the vehicle 510, the animal 520, and/or the falling object 530) according to an embodiment of the disclosure. The wearable device 200 according to an embodiment of the disclosure may perform beamforming with respect to the identified object (e.g., toward the identified object). According to an embodiment of the disclosure, the wearable device 200 may identify a location of at least one external object (e.g., the vehicle 510, the animal 520, and/or the falling object 530) based on an image captured by at least one camera (e.g., the second camera module 253), and, based on the identified location, may perform beamforming through the microphone module 247 (e.g., a first microphone 247a, a second microphone 247b, a third microphone 247c, a fourth microphone 247d, a fifth microphone 247e, a sixth microphone 247f, a seventh microphone 247g, an eighth microphone 247h, and/or a ninth microphone 247i). According to an embodiment of the disclosure, the wearable device 200 may perform beamforming through the microphone module 247 (e.g., the first microphone 247a, the second microphone 247b, the third microphone 247c, the fourth microphone 247d, the fifth microphone 247e, the sixth microphone 247f, the seventh microphone 247g, the eighth microphone 247h, and/or the ninth microphone 247i) toward a sound signal generated from at least one external object (e.g., the vehicle 510, the animal 520, and/or the falling object 530). According to an embodiment of the disclosure, the wearable device 200 may perform beamforming through the microphone module 247 (e.g., the first microphone 247a, the second microphone 247b, the third microphone 247c, the fourth microphone 247d, the fifth microphone 247e, the sixth microphone 247f, the seventh microphone 247g, the eighth microphone 247h, and/or the ninth microphone 247i) with respect to at least one external object (e.g., the vehicle 510, the animal 520, and/or the falling object 530) in the line of sight that the user 500 is gazing at.

According to an embodiment of the disclosure, the wearable device 200 may perform beamforming using at least one microphone disposed in a direction in which at least one external object (e.g., the vehicle 510, the animal 520, and/or the falling object 530) is located. For example, the wearable device 200 according to an embodiment of the disclosure, in the case of identifying that at least one object (e.g., the vehicle 510) is located at the right rear side of the user 500 (e.g., approaching toward the user) as illustrated in FIG. 5, may perform beamforming (e.g., establish a first beam area 510a) by using some microphones (e.g., the seventh microphone 247g, the eighth microphone 247h, and/or the ninth microphone 247i) disposed on the right side among the a plurality of microphones (e.g., the first microphone 247a, the second microphone 247b, the third microphone 247c, the fourth microphone 247d, the fifth microphone 247e, the sixth microphone 247f, the seventh microphone 247g, the eighth microphone 247h, and/or the ninth microphone 247i). According to an embodiment of the disclosure, the wearable device 200, in the case of identifying that at least one object (e.g., the animal 520) is located at the left front side of the user 500 (e.g., approaching toward the user) as illustrated in FIG. 5, may perform beamforming (e.g., establish a second beam area 520a) by using some microphones (e.g., the second microphone 247b, the third microphone 247c, and/or the fourth microphone 247d) disposed on the left front side among the a plurality of microphones (e.g., the first microphone 247a, the second microphone 247b, the third microphone 247c, the fourth microphone 247d, the fifth microphone 247e, the sixth microphone 247f, the seventh microphone 247g, the eighth microphone 247h, and/or the ninth microphone 247i). According to an embodiment of the disclosure, the wearable device 200, in the case of identifying that at least one object (e.g., the falling object 530) is located in the left direction of the user 500 (e.g., falling around the user 500) as illustrated in FIG. 5, may perform beamforming (e.g., establish a third beam area 530a) by using some microphones (e.g., the first microphone 247a, the second microphone 247b, and/or the third microphone 247c) disposed in the left direction among the a plurality of microphones (e.g., the first microphone 247a, the second microphone 247b, the third microphone 247c, the fourth microphone 247d, the fifth microphone 247e, the sixth microphone 247f, the seventh microphone 247g, the eighth microphone 247h, and/or the ninth microphone 247i).

According to an embodiment of the disclosure, at least one microphone to perform beamforming may have been designated according to the location of the at least one external object (e.g., the vehicle 510, the animal 520, and/or the falling object 530). For example, according to an embodiment of the disclosure, an area around the user 500 may be partitioned and each of the partitioned areas may have at least one microphone matched to perform beamforming. According to an embodiment of the disclosure, the at least one microphone to perform beamforming may be designated by the user 500,

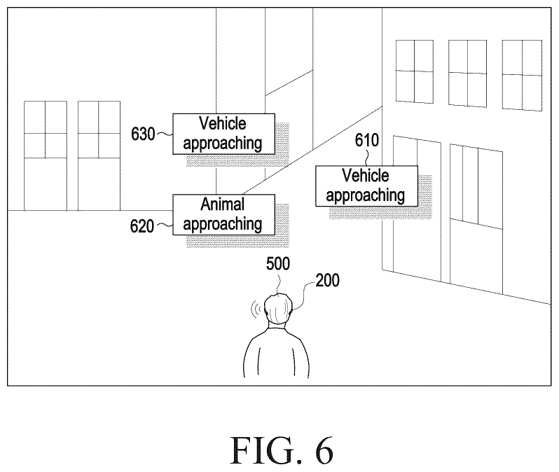

According to an embodiment of the disclosure, the wearable device 200 (e.g., the electronic device 101 in FIG. 1), in operation 420, may output a notification corresponding to at least one external object (e.g., the vehicle 510, the animal 520, and/or the falling object 530). FIG. 6 is a view illustrating a function or operation of providing a notification (e.g., a first visual notification 610, a second visual notification 620, a third visual notification 630, an sound notification 640, and/or a tactile notification) with respect to a plurality of external objects (e.g., the vehicle 510, the animal 520, and/or the falling object 530) through a wearable device according to an embodiment of the disclosure. According to an embodiment of the disclosure, the wearable device 200 may provide a virtual object (e.g., the first visual notification 610, the second visual notification 620, and/or the third visual notification 630) as a notification (e.g., the first visual notification 610, the second visual notification 620, the third visual notification 630, and/or the sound notification 640) corresponding to at least one external object (e.g., the vehicle 510, the animal 520, and/or the falling object 530) or the sound notification 640 (e.g., a notification designated according to an external object or a sound signal generated from at least one external object (e.g., the vehicle 510, the animal 520, and/or the falling object 530)). According to an embodiment of the disclosure, the wearable device 200 may control the display module (e.g., the light output module 211 or the display 321) to provide the virtual object (e.g., the first visual notification 610, the second visual notification 620, and/or the third visual notification 630).

According to an embodiment of the disclosure, the wearable device 200 may control the speaker module 245 to provide the sound notification 640. According to an embodiment of the disclosure, the wearable device 200, in the case of providing the sound notification 640, may highlight (e.g., amplify a volume) and output a specific frequency band according to a type of at least one external object (e.g., the vehicle 510, the animal 520, and/or the falling object 530) so as to emphasize a sound signal generated from the identified at least one external object (e.g., the vehicle 510, the animal 520, and/or the falling object 530). For example, the wearable device 200 according to an embodiment of the disclosure may highlight and output a low frequency in the case of a specific external object (e.g., the vehicle 510) and highlight and output a mid/high frequency in the case of a human voice. For example, frequency bands other than the highlighted one may be weakened (e.g., reduce a volume) and output.

According to an embodiment of the disclosure, the wearable device 200 (e.g., the electronic device 101 in FIG. 1), in operation 430, may identify movement (e.g., movement of the user 500 wearing the wearable device 200) of the wearable device 200, in which the wearable device 200 is rotating toward at least one external object (e.g., the vehicle 510). According to an embodiment of the disclosure, the wearable device 200, based on an image captured by the camera module (e.g., the second camera module 253) and/or a direction of a sound signal acquired through the speaker module 245, may identify a direction (e.g., a direction established in the first beam area 510a) of at least one external object (e.g., the vehicle 510). According to an embodiment of the disclosure, the wearable device 200 may identify a rotation direction and/or a rotation angle of the wearable device 200 by using sensing data acquired by at least one sensor (e.g., a gyro sensor and/or acceleration sensor) included in the wearable device 200. Alternatively, the wearable device 200 according to an embodiment of the disclosure may identify a rotation direction and/or a rotation angle of the wearable device 200, based on a direction of a sound signal acquired by the microphone module. By using such information (e.g., the direction in which at least one external object (e.g., the vehicle 510) is located, or the rotation direction and/or the rotation angle of the wearable device 200), the wearable device 200 according to an embodiment of the disclosure may identify a direction in which the user 500 wearing the wearable device 200 has rotated (e.g., which external object is located in the direction in which the head has rotated).

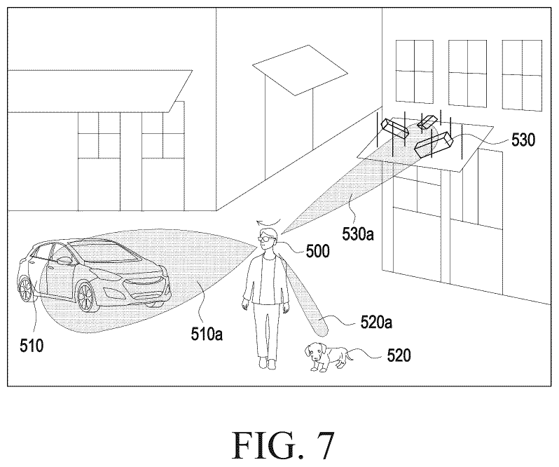

According to an embodiment of the disclosure, the wearable device 200 (e.g., the electronic device 101 in FIG. 1), in operation 440, may highlight and output a notification (e.g., the first visual notification 610, the sound notification 640, and/or the tactile notification) with respect to at least one object (e.g., the vehicle 510) while maintaining beamforming with respect to the at least one external object (e.g., the vehicle 510). FIG. 7 is a view illustrating a function or operation of, in a case in which a user 500 wearing a wearable device 200 rotates (e.g., shifting of gaze) toward one (e.g., a vehicle 510) of a plurality of external objects (e.g., the vehicle 510, an animal 520, and/or a falling object 530), maintaining beamforming with respect to the one external object (e.g., the vehicle 510) according to an embodiment of the disclosure. Referring to FIG. 7, the wearable device 200 according to an embodiment of the disclosure, in the case of rotating (e.g., shifting of gaze) toward one external object (e.g., the vehicle 510) of the a plurality of external objects (e.g., the vehicle 510, the animal 520, and/or the falling object 530), may emphasize (e.g., extend the first beam area 510a) beamforming with respect to the one external object (e.g., the vehicle 510). For example, according to an embodiment of the disclosure, beamforming with respect to the remaining objects (e.g., the animal 520 and/or the falling object 530) may be weakened (e.g., reduce the second beam area 520a and the third beam area 530a) or may not perform beamforming. According to an embodiment of the disclosure, the wearable device 200 may emphasize (e.g., extend the first beam area 510a) beamforming or weaken (e.g., reduce the second beam area 520a and the third beam area 530a) by adding or excluding a microphone.

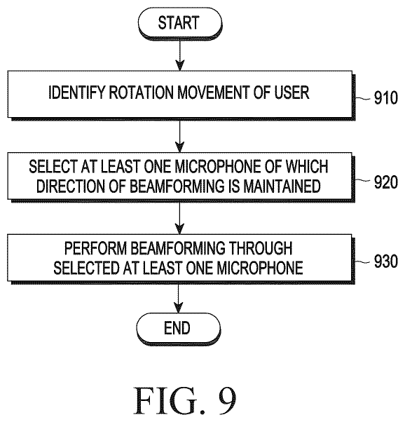

According to an embodiment of the disclosure, the wearable device 200, based on a level of risk, may highlight and output a notification (e.g., the first visual notification 610, the sound notification 640, and/or the tactile notification) with respect to at least one object (e.g., the vehicle 510). According to an embodiment of the disclosure, the wearable device 200 may output a notification with respect to at least one object (e.g., the vehicle 510 and/or the falling object 530) having relatively high risk to be more highlighted than at least one object (e.g., the animal 520) having relatively low risk. The level of risk according to an embodiment of the disclosure may have been designated according to at least one object for each level. The function or operation of maintaining beamforming according to the rotation of the wearable device 200 according to an embodiment of the disclosure will be described in detail with reference to FIGS. 9 to 12C.

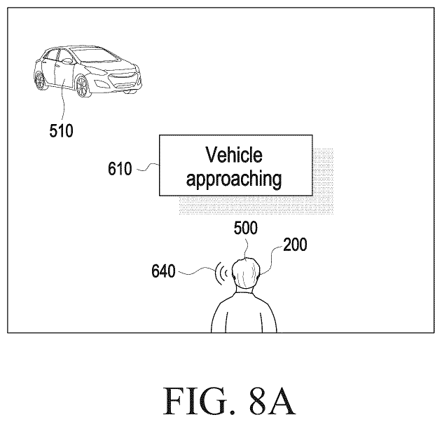

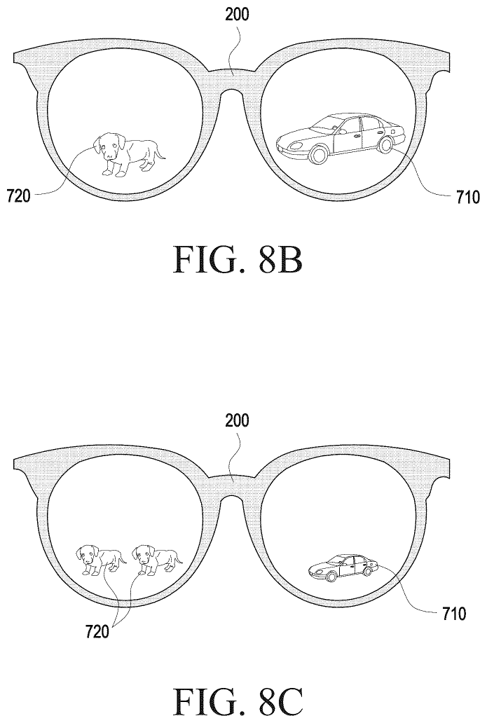

FIG. 8A is a view illustrating a function or operation of highlighting a notification (e.g., the first visual notification 610 and/or the sound notification 640) with respect to one external object (e.g., the vehicle 510) and providing same to a user according to an embodiment of the disclosure. FIGS. 8B and 8C are views illustrating various types of notifications with respect to a plurality of external objects (e.g., the vehicle 510, the animal 520, and/or the falling object 530) according to an embodiment of the disclosure. Referring to FIG. 8A, the wearable device 200 according to an embodiment of the disclosure, in a case in which rotation with respect to one object (e.g., the vehicle 510) is identified, may enlarge the size of the provided notification (e.g., the first visual notification 610) and provided the notification to the user 500 as a virtual object in the manner of augmented reality or virtual reality. For example, notifications (e.g., the second visual notification 620 and/or the third visual notification 630) corresponding to the remaining external objects (e.g., the animal 520 and/or the falling object 530) may not be provided as virtual objects, or may be provided at a reduced size from the size illustrated before the rotation of the wearable device 200 was identified. According to an embodiment of the disclosure, the wearable device 200, in a case in which rotation with respect to one object (e.g., the vehicle 510) has been identified, may output the sound notification 640 corresponding to the one object (e.g., the vehicle 510) by increasing a volume thereof to be greater than the volume output before the rotation of the wearable device 200 was identified. For example, the sound notification 640 corresponding to the remaining external objects (e.g., the animal 520 and/or the falling object 530) may not be provided, or may be provided at a reduced volume from the volume output before the rotation of the wearable device 200 was identified. According to an embodiment of the disclosure, the wearable device 200, in a case in which rotation with respect to one object (e.g., the vehicle 510) has been identified, may output the tactile notification by increasing a strength thereof to be greater than the strength of the tactile notification output before the rotation of the wearable device 200 was identified.

The notification (e.g., the visual notification) according to an embodiment of the disclosure may be provided in a form corresponding to external objects. Referring to FIGS. 8B and 8C, the visual notification according to an embodiment of the disclosure may include an image captured by the camera module (e.g., the second camera module 253) as a virtual object illustrated to the user 500. For example, the wearable device 200 according to an embodiment of the disclosure may provide an image having a first field of view (e.g., a relatively narrow field of view) as a virtual object and an image having a second field of view (e.g., a field of view wider than the first field of view) as a virtual object. An image captured by the camera module (e.g., the second camera module 253) according to an embodiment of the disclosure may include an image corresponding to at least one external object (e.g., the vehicle 510 and/or the animal 520).

With respect to FIG. 4, for convenience of explanation, it is illustrated when the wearable device 200 rotates toward a one external object (e.g., the vehicle 510), but the description with respect to FIG. 4 may equally apply when the wearable device 200 rotates toward a plurality of external objects.

FIG. 9 is a view illustrating a function or operation of, in a case in which a user wearing a wearable device 200 rotates (e.g., shifting of gaze) toward one (e.g., the vehicle 510) of a plurality of external objects (e.g., the vehicle 510, the animal 520, and/or the falling object 530), changing at least some of microphones (e.g., the first microphone 247a, the second microphone 247b, and/or the third microphone 247c) which are performing beamforming to another microphone (e.g., the third microphone 247c, the fourth microphone 247d, the fifth microphone 247e, the sixth microphone 247f, and/or the seventh microphone 247g) so as to maintain beamforming with respect to one object (e.g., the vehicle 510) according to an embodiment of the disclosure.

Referring to FIG. 9, the wearable device 200 according to an embodiment of the disclosure, in operation 910, may identify rotation movement of the wearable device 200. According to an embodiment of the disclosure, the wearable device 200, based on an image captured by the camera module (e.g., the second camera module 253) and/or a direction of a sound signal acquired through the speaker module 245, may identify a direction (e.g., a direction established in the first beam area 510a) of at least one external object (e.g., the vehicle 510). According to an embodiment of the disclosure, the wearable device 200 may identify a rotation direction and/or a rotation angle of the wearable device 200 by using sensing data acquired by at least one sensor (e.g., a gyro sensor and/or acceleration sensor) included in the wearable device 200. Alternatively, the wearable device 200 according to an embodiment of the disclosure may identify a rotation direction and/or a rotation angle of the wearable device 200, based on a direction of a sound signal acquired by the microphone module. By using such information (e.g., the direction in which at least one external object (e.g., the vehicle 510) is located, or the rotation direction and/or the rotation angle of the wearable device 200), the wearable device 200 according to an embodiment of the disclosure may identify a direction in which the user 500 wearing the wearable device 200 has rotated (e.g., which external object is located in the direction in which the head has rotated).

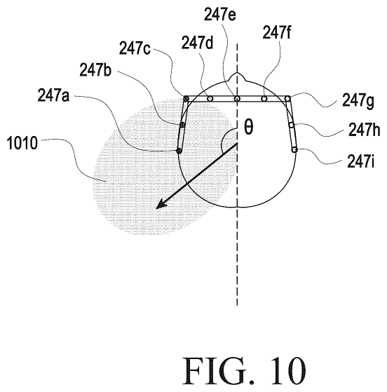

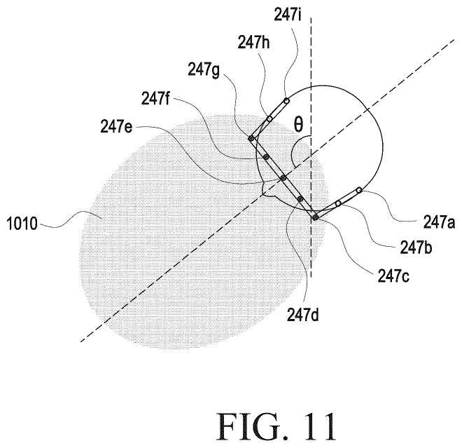

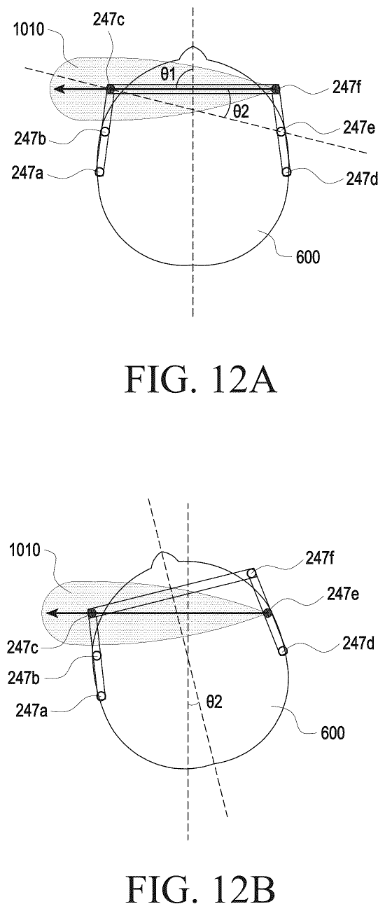

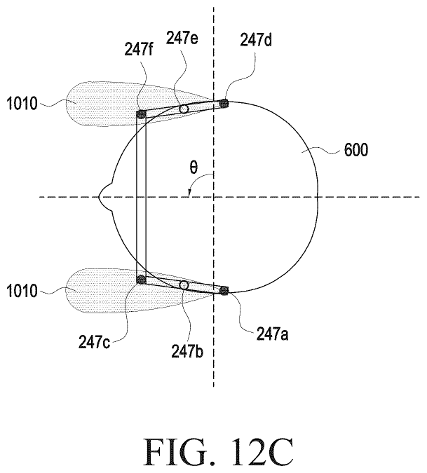

According to an embodiment of the disclosure, the wearable device 200, in operation 920, may select at least one microphone which maintains a direction of beamforming. FIG. 10 is a view illustrating a function or operation of performing beamforming with respect to a specific external object (e.g., the vehicle 510) by using some (e.g., the first microphone 247a, the second microphone 247b, and/or the third microphone 247c) of a plurality of microphones (e.g., the first microphone 247a, the second microphone 247b, the third microphone 247c, the fourth microphone 247d, the fifth microphone 247e, the sixth microphone 247f, the seventh microphone 247g, the eighth microphone 247h, and/or the ninth microphone 247i) according to an embodiment of the disclosure. FIG. 11 is a view illustrating a function or operation of, in a case in which a user 500 wearing a wearable device 200 rotates by a specific angle (e.g., 0), changing at least some of microphones (e.g., the first microphone 247a, the second microphone 247b, and/or the third microphone 247c) which are performing beamforming to other microphones (e.g., the third microphone 247c, the fourth microphone 247d, the fifth microphone 247e, the sixth microphone 247f, and/or the seventh microphone 247g) so as to maintain beamforming being performed with respect to a specific external object (e.g., the vehicle 510) according to an embodiment of the disclosure. FIGS. 12A to 12C are views illustrating a function or operation of, in a case in which a user 500 wearing a wearable device 200 rotates by a specific angle (e.g., 0), maintaining directivity of a beam according to an embodiment of the disclosure.

Referring to FIGS. 10 and 11, the wearable device 200 according to an embodiment of the disclosure may perform beamforming with respect to at least one external object (e.g., the vehicle 510). According to an embodiment of the disclosure, the at least one external object is located at the left rear side of the user 500, and thus the wearable device 200 may perform beamforming toward the left rear side by using a plurality of microphones (e.g., the first microphone 247a, the second microphone 247b, and/or the third microphone 247c) located at the left side. In FIG. 10, it is illustrated that a beam area 1010 (e.g., the first beam area 510a) is established at the left rear side according to the beamforming with respect to the at least one object (e.g., when the beam area 1010 is established at an angle of θ relative to when the user 500 is facing forward). According to an embodiment of the disclosure, the wearable device 200 may control the remaining microphones (e.g., the third microphone 247c, the fourth microphone 247d, the fifth microphone 247e, the sixth microphone 247f, the seventh microphone 247g, the eighth microphone 247h, and/or the ninth microphone 247i) not performing the beamforming to operate at low power or turn (e.g., deactivate) the remaining microphones off. According to an embodiment of the disclosure, the wearable device 200 may control (e.g., reduce) a voltage or clock applied to the remaining microphones (e.g., the third microphone 247c, the fourth microphone 247d, the fifth microphone 247e, the sixth microphone 247f, the seventh microphone 247g, the eighth microphone 247h, and/or the ninth microphone 247i) not performing the beamforming to cause the remaining microphones to operate at low power or to be deactivated. According to an embodiment of the disclosure, the wearable device 200 may control an operation voltage input to at least one microphone to control an operation of the at least one microphone. According to an embodiment of the disclosure, the wearable device 200 may control an input clock input to at least one microphone to control an operation of the at least one microphone. According to an embodiment of the disclosure, the wearable device 200 may control an operation of at least one microphone based on a control signal transmitted to the at least one microphone from an external device.

Referring to FIG. 11, the wearable device 200 according to an embodiment of the disclosure, in a case in which the user 500 rotates (e.g., shifting of gaze) to the left rear side (e.g., in a case of rotating by an angle of θ relative to when the wearable device 200 and/or the user 500 is facing forward), may compensate for the rotated angle and select at least one microphone to perform beamforming. According to an embodiment of the disclosure, the wearable device 200 may maintain the performance of beamforming by using at least one microphone disposed at an angle of θ relative to when the user 500 is facing forward and at least one microphone disposed in a periphery of the microphone disposed at an angle of θ relative to when the user 500 is facing forward. According to an embodiment of the disclosure, in order to acquire information regarding an angle (e.g., θ), the wearable device 200 according to an embodiment of the disclosure may identify (e.g., calculate) a direction in which the beamforming is established and the angle configured by each of the microphones, based on when the user 500 is facing forward. According to an embodiment of the disclosure, the wearable device 200 may select at least one microphone to maintain the beamforming based on the identified angle (e.g., θ) so as to compensate for a rotation angle according to the rotation of the user 500. According to an embodiment of the disclosure, the number of at least one microphone (e.g., the third microphone 247c, the fourth microphone 247d, the sixth microphone 247f, and/or the seventh microphone 247g) disposed in the periphery of the microphone (e.g., the fifth microphone 247e) disposed at an angle of θ relative to when the user 500 is facing forward may be designated or determined by selection of the user 500.

Referring to FIG. 12A, the wearable device 200 according to an embodiment of the disclosure may perform the beamforming in the left direction relative to a state where the user 500 is facing forward. According to an embodiment of the disclosure, θ1 in FIG. 12A may be substantially 90°. The wearable device 200 according to an embodiment of the disclosure may perform the beamforming in the left direction relative to a state where the user 500 is facing forward by using the third microphone 247c and the sixth microphone 247f. For example, the third microphone 247c and the sixth microphone 247f according to an embodiment of the disclosure may be operated at full power performance, while the other remaining microphones may be operated at lower power or deactivated (e.g., turned off). According to an embodiment of the disclosure, the wearable device 200 may identify (e.g., calculate) an angle configured by the direction of the established beam area 1010 and each microphone (e.g., the fifth microphone 247e). For example, the wearable device 200 according to an embodiment of the disclosure, as illustrated in FIG. 12A, may identify that the angle configured by the direction of the established beam area 1010 and a specific microphone (e.g., the fifth microphone 247e) is θ2 (e.g., 20°).

Referring to FIG. 12B, according to an embodiment of the disclosure, the wearable device 200, in a case in which the user 500 has rotated substantially (e.g., including a designated error range) by an angle of θ2 (e.g., 20°), may change a microphone being used by the wearable device 200 for performing the beamforming to maintain the beamforming in the left direction. For example, the wearable device 200 according to an embodiment of the disclosure may change a microphone being used by the wearable device 200 for performing the beamforming from the sixth microphone 247f to the fifth microphone 247e to perform the beamforming. According to an embodiment of the disclosure, the wearable device 200 may selectively perform the beamforming using all of the third microphone 247c, the fifth microphone 247e, and the sixth microphone 247f. Referring to FIG. 12C, according to an embodiment of the disclosure, the wearable device 200, in a case in which the user 500 has rotated substantially (e.g., including a designated error range) by 90°, may change (e.g., add) a microphone being used by the wearable device 200 for performing the beamforming to maintain the beamforming in the left direction. For example, the wearable device 200 according to an embodiment of the disclosure may perform the beamforming by using the first microphone 247a, the third microphone 247c, the fourth microphone 247d, and the sixth microphone 247f to maintain the beamforming in the left direction. According to an embodiment of the disclosure, the wearable device 200 may selectively perform the beamforming using all of the first microphone 247a, the second microphone 247b, the third microphone 247c, the fourth microphone 247d, the fifth microphone 247e, and the sixth microphone 247f.

According to an embodiment of the disclosure, the wearable device 200, in operation 930, may perform the beamforming through the at least one microphone selected according to operation 920. For example, the wearable device 200 according to an embodiment of the disclosure, in a case in which the user 500 has rotated substantially (e.g., including a designated error range) by an angle of θ2 (e.g., 20°), may change a microphone being used by the wearable device 200 for performing the beamforming from the sixth microphone 247f to the fifth microphone 247e to perform the beamforming. As such, the rotation movement of the user 500 may be compensated for by a function or operation of the disclosure, such that the direction in which the beamforming is performed is maintained despite the rotation of the user 500 (e.g., shifting of gaze).

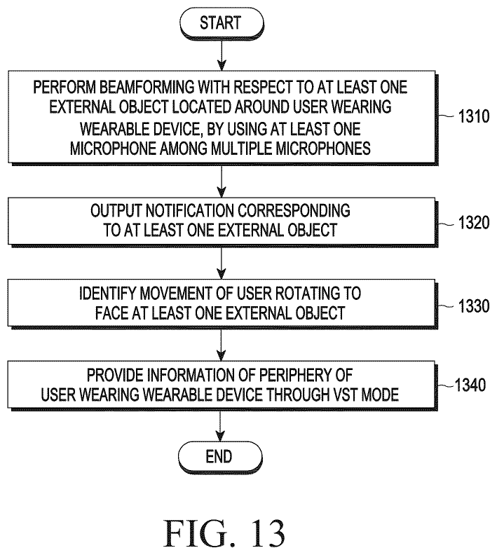

FIG. 13 is a view illustrating a function or operation of, in a case in which a user 500 wearing a wearable device 200 rotates (e.g., shifting of gaze) toward a specific external object (e.g., a vehicle), switching to a video see through (VST) mode according to an embodiment of the disclosure.

Referring to FIG. 13, the wearable device 200 (e.g., the electronic device 101 in FIG. 1) according to an embodiment of the disclosure, in operation 1310, may perform beamforming with respect to at least one external object (e.g., the vehicle 510, the animal 520, or the falling object 530) located around the user 500 wearing the wearable device 200 by using at least one microphone (e.g., the first microphone 247a and the second microphone 247b) among a plurality of microphones (e.g., the microphone module 247).

According to an embodiment of the disclosure, the wearable device 200 (e.g., the electronic device 101 in FIG. 1), in operation 1320, may output a notification corresponding to at least one external object (e.g., the vehicle 510, the animal 520, and/or the falling object 530).

According to an embodiment of the disclosure, the wearable device 200 (e.g., the electronic device 101 in FIG. 1), in operation 1330, may identify movement of the user 500 rotating toward at least one external object (e.g., the vehicle 510). According to an embodiment of the disclosure, the wearable device 200, based on an image captured by the camera module (e.g., the second camera module 253) and/or a direction of a sound signal acquired through the speaker module 245, may identify a direction (e.g., a direction established in the first beam area 510a) of at least one external object (e.g., the vehicle 510). According to an embodiment of the disclosure, the wearable device 200 may identify a rotation direction and/or a rotation angle of the wearable device 200 by using sensing data acquired by at least one sensor (e.g., a gyro sensor and/or acceleration sensor) included in the wearable device 200. Alternatively, the wearable device 200 according to an embodiment of the disclosure may identify a rotation direction and/or a rotation angle of the wearable device 200, based on a direction of a sound signal acquired by the microphone module. By using such information (e.g., the direction in which at least one external object (e.g., the vehicle 510) is located, or the rotation direction and/or the rotation angle of the wearable device 200), the wearable device 200 according to an embodiment of the disclosure may identify a direction in which the user 500 wearing the wearable device 200 has rotated (e.g., which external object is located in the direction in which the head has rotated).

According to an embodiment of the disclosure, the wearable device 200 (e.g., the electronic device 101 in FIG. 1), in operation 1430, may provide information of a periphery of the user 500 wearing the wearable device 200 through a video see through (VST) mode. According to an embodiment of the disclosure, the wearable device 200 may provide information of an image of the periphery of the user 500 captured by the camera module (e.g., the camera modules 311 and 312) through the display (e.g., the display 321) while highlighting beamforming with respect to a specific external object (e.g., the vehicle 510). According to an embodiment of the disclosure, the VST mode may indicate a mode configured to provide information of an image of the periphery of the user 500 captured by the camera module (e.g., the camera modules 311 and 312) through the display (e.g., the display 321). Such function or operation may allow the user 500 to be intuitively informed of the surroundings of the user.

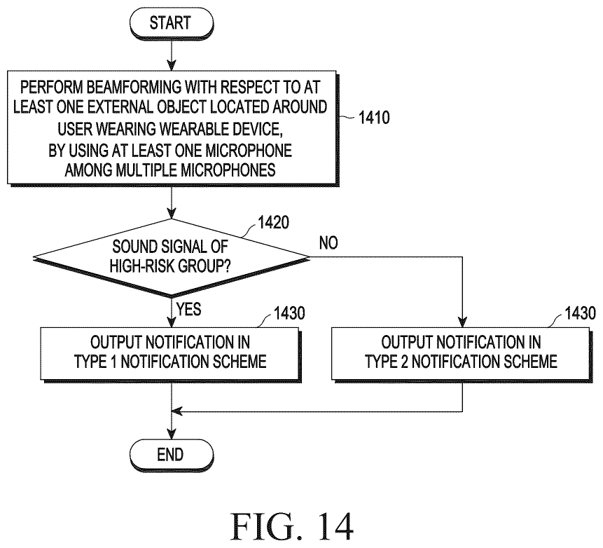

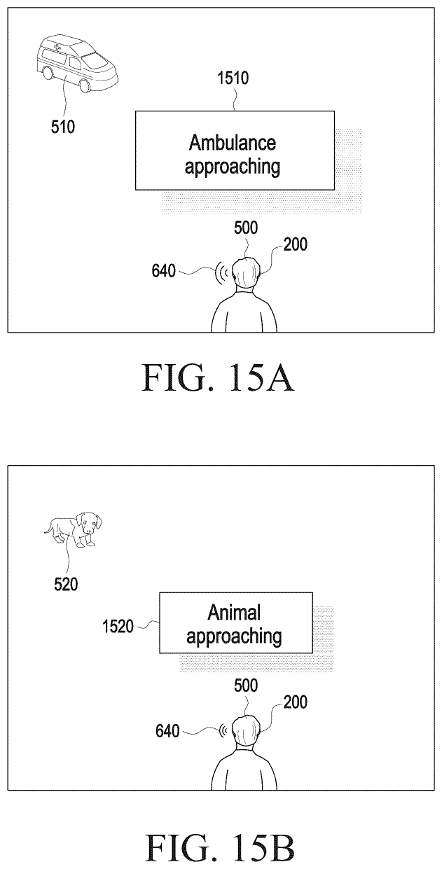

FIG. 14 is a view illustrating a function or operation of determining a type of a notification, based on whether a sound signal generated from an external object (e.g., an ambulance) located around a user 500 wearing a wearable device 200 is a sound signal included in a designated risk group, and providing the notification to the user according to the determined type of the notification according to an embodiment of the disclosure. FIGS. 15A and 15B are views illustrating a type 1 notification 1510 and a type 2 notification 1520 according to an embodiment of the disclosure.

In the descriptions of the operations herein, the operations may be performed in a different order than the order shown and/or described, or the operations may be performed in different orders or at different times. Certain operations may also be left out of, one or more operations may be repeated, or other operations may be added.

Referring to FIG. 14, the wearable device 200 (e.g., the electronic device 101 in FIG. 1) according to an embodiment of the disclosure, in operation 1410, may perform beamforming with respect to at least one external object (e.g., the vehicle 510, an animal 520, or a falling object 530) located around the user 500 wearing the wearable device 200 by using at least one microphone (e.g., a first microphone 247a and a second microphone 247b) among a plurality of microphones (e.g., the microphone module 247).

According to an embodiment of the disclosure, the wearable device 200 (e.g., the electronic device 101 in FIG. 1), in operation 1420, may determine whether the sound signal generated from at least one external object (e.g., the vehicle 510, the animal 520, and the falling object 530) is a sound signal of a high-risk group. According to an embodiment of the disclosure, the signal included in the high-risk group may be designated by the user or have been designated. For example, the wearable device 200 according to an embodiment of the disclosure may select, on a user interface provided through the wearable device 200, a type of a sound signal included in the high-risk group or a type of at least one external object (e.g., the vehicle 510 or the ambulance). According to an embodiment of the disclosure, the wearable device 200 may compare a sound signal generated from at least one external object (e.g., the vehicle 510, the animal 520, and the falling object 530) with a sound signal stored in the wearable device 200 that is configured to be included in the high-risk group. According to an embodiment of the disclosure, the wearable device 200 may determine, based on a result of the comparison, whether the sound signal generated from at least one external object (e.g., the vehicle 510, the animal 520, and the falling object 530) is a sound signal included in the high-risk group.

According to an embodiment of the disclosure, the wearable device 200 (e.g., the electronic device 101 in FIG. 1), in operation 1430, in a case in which the wearable device 200 has determined that the sound signal generated from at least one external object (e.g., the vehicle 510, the animal 520, and the falling object 530) is a sound signal included in the high-risk group (e.g., operation 1420—Yes), may output a notification in a type 1 notification scheme. The type 1 notification scheme according to an embodiment of the disclosure may be a notification scheme having a size greater than that of a visual notification of a type 2 notification scheme (e.g., a representation scheme of a visual notification illustrated in FIG. 15B), or a volume greater than that of an sound notification of the type 2 notification scheme, or a strength greater than that of a tactile notification of the type 2 notification scheme, as illustrated in FIG. 15A.

According to an embodiment of the disclosure, the wearable device 200 (e.g., the electronic device 101 in FIG. 1), in operation 1430, in a case in which it is determined that the sound signal generated from at least one external object (e.g., the vehicle 510, the animal 520, and the falling object 530) is a sound signal not included in the high-risk group (e.g., operation 1420—No), may output a notification in the type 2 notification scheme. The type 2 notification scheme according to an embodiment of the disclosure may be a notification scheme having a size smaller than that of the visual notification of the type 1 notification scheme (e.g., a representation scheme of the visual notification illustrated in FIG. 15A), or a volume smaller than that of the sound notification of the type 2 notification scheme, or a strength smaller than that of the tactile notification of the type 1 notification scheme, as illustrated in FIG. 15B.

The function or operation according to the embodiment of the disclosure illustrated in FIG. 14 may be performed in association with FIG. 4. For example, the wearable device 200 according to an embodiment of the disclosure, in a case in which the at least one external object (e.g., the vehicle 510) is an ambulance, may control the wearable device 200 to change an attribute of the notification (e.g., increase the size of the visual notification) to be provided to the user 500.

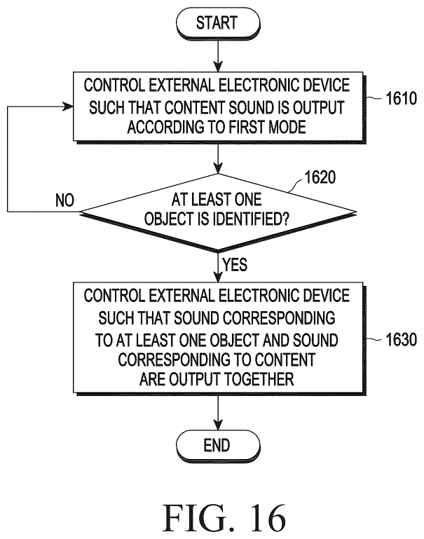

FIG. 16 is a view illustrating a function or operation of, in a case in which at least one external object (e.g., the vehicle 510) is identified when a wearable device 200 and an external electronic device are operatively connected, outputting a content sound together with a sound generated from the at least one external object (e.g., the vehicle 510) through the external electronic device according to an embodiment of the disclosure.

Referring to FIG. 16, the wearable device 200 according to an embodiment of the disclosure, in operation 1610, may control the external electronic device to output a content sound according to a first mode (e.g., a noise-canceling mode).

According to an embodiment of the disclosure, the wearable device 200, in operation 1620, may identify at least one object (e.g., the vehicle 510). The wearable device 200 according to an embodiment of the disclosure may identify at least one external object (e.g., the vehicle 510, the animal 520, and/or the falling object 530) located around the user 500 wearing the wearable device 200 by analyzing (e.g., comparing a shape of an external object with a shape stored in the wearable device 200) an image captured by at least one camera (e.g., the second camera module 253) capable of capturing a periphery of the user 500 wearing the wearable device 200. According to an embodiment of the disclosure, the wearable device 200, based on a sound signal generated from at least one external object (e.g., the vehicle 510, the animal 520, and/or the falling object 530), may identify at least one external object (e.g., the vehicle 510, the animal 520, and/or the falling object 530) (e.g., determine at least one external object as an object on which beamforming is to be performed).

According to an embodiment of the disclosure, the wearable device 200, in operation 1630, in a case in which the at least one external object (e.g., the vehicle 510) is identified, may control the external electronic device to output a sound signal corresponding to the at least one external object (e.g., the vehicle 510) together with a sound signal corresponding to the content through the external electronic device. According to an embodiment of the disclosure, the wearable device 200 may transmit, to the external electronic device, information for the sound signal corresponding to the at least one external object (e.g., the vehicle 510) such that the sound signal (e.g., the sound signal generated from the at least one external object (e.g., the vehicle 510)) corresponding to the at least one external object (e.g., the vehicle 510) is output through the external electronic device. According to an embodiment of the disclosure, the wearable device 200 may output a pre-stored sound signal corresponding to at least one object together with a sound signal corresponding to the content, together with the sound corresponding to the at least one external object (e.g., the vehicle (510)) or instead of the sound corresponding to the at least one external object (e.g., the vehicle (510)).

In accordance with the function or operation of an embodiment of the disclosure, the user 500 may be able to facilitate the identification of access to a risk factor, even while listening to content sounds (e.g., music) through the external electronic device.

A wearable device 200 according to an embodiment of the disclosure may include a plurality of microphones (e.g., a first microphone 247a, a second microphone 247b, a third microphone 247c, a fourth microphone 247d, a fifth microphone 247e, a sixth microphone 247f, a seventh microphone 247g, an eighth microphone 247h, and/or a ninth microphone 247i), a display module (e.g., the light output module 211), at least one speaker (e.g., the speaker module 245), and at least one processor (e.g., the processor 120), wherein the at least one processor may be configured to perform beamforming with respect to at least one object located around a user wearing the wearable device, by using at least one microphone among the a plurality of microphones, output, based on performing the beamforming, a notification corresponding to the at least one object through the at least one speaker and/or the display module, identify movement of the user rotating to face an object among a plurality of objects, and highlight and output, based on identifying the movement, through the at least one speaker or the display module, the notification corresponding to the at least one object while maintaining the beamforming with respect to the at least one object.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described herein.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “substantially,” as used herein, means approximately or actually. The term “substantially equal” means approximately or actually equal. The term “substantially the same” means approximately or actually the same. The term “substantially perpendicular” means approximately or actually perpendicular. The term “substantially parallel” means approximately or actually parallel.

Various embodiments as set forth herein may be implemented as software (e.g., the program 2540) including one or more instructions that are stored in a storage medium (e.g., internal memory 2536 or external memory 2538) that is readable by a machine (e.g., the electronic device 2501). For example, a processor (e.g., the processor 2520) of the machine (e.g., the electronic device 2501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable device comprising:
a plurality of microphones;
a display module;
at least one speaker;
at least one processor; and
memory storing instructions that, when executed by the at least one processor individually or collectively, cause the wearable device to:
perform, by using at least one microphone among the plurality of microphones, beamforming with respect to a plurality of objects located around the wearable device;
based on the performing of the beamforming, output a notification corresponding to the plurality of objects through at least one of the at least one speaker or the display module;
identify movement of the wearable device in which the wearable device is rotating to face an object among the plurality of objects; and
based on the identifying of the movement, highlight and output the notification corresponding to the object through at least one of the at least one speaker or the display module while maintaining the beamforming with respect to the plurality of objects.

2. The wearable device of claim 1, further comprising at least one camera,
wherein the instructions cause the wearable device to, based on an image captured by the at least one camera and a sound obtained by the plurality of microphones, identify whether the plurality of objects is located around the wearable device.

3. The wearable device of claim 1, wherein the instructions cause the wearable device to, in a case in which the movement of the wearable device is identified, perform beamforming by using at least one other microphone different from the at least one microphone being used for performing the beamforming.

4. The wearable device of claim 1, wherein the instructions cause the wearable device to control one or more remaining microphones other than the at least one microphone among the plurality of microphones such that the one or more remaining microphones are:
operated at low power, minimized performance, or both; or
deactivated.

5. The wearable device of claim 1, wherein the instructions cause the wearable device to, in a case in which the movement of the wearable device is identified, increase a volume of the notification output through the at least one speaker or output a designated sound effect.

6. The wearable device of claim 1, wherein the instructions cause the wearable device to, in a case in which the movement of the wearable device is identified, control the display module such that a size of the notification is changed based on a level of risk is output through the display module.

7. The wearable device of claim 1, wherein the instructions cause the wearable device to control the display module such that a virtual object corresponding to shapes of the plurality of objects are output through the display module.

8. The wearable device of claim 1, wherein the instructions cause the wearable device to, in a case in which the movement of the wearable device is identified, control at least one camera comprised in the wearable device such that the wearable device is operated in a video see through (VST) mode which directly shows an external environment.

9. The wearable device of claim 1, wherein the instructions cause the wearable device to:
determine whether a sound generated from the object is a sound belonging to a configured high-risk group; and
in a case in which the wearable device determines that the sound generated from the object is a sound belonging to the configured high-risk group, control the at least one speaker or the display module such that the notification output through the at least one speaker is output at a volume greater than or equal to a designated magnitude or the notification output through the display module is output at a size greater than or equal to a designated size.

10. The wearable device of claim 1, wherein the instructions cause the wearable device to, in a case in which the plurality of objects are identified, control an external electronic device operatively connected to the wearable device such that at least one of a sound generated from the plurality of objects or a prestored sound corresponding to the plurality of objects are output together with a content sound being output by the external electronic device.

11. A method for controlling a wearable device, the method comprising:
performing, by using at least one microphone among a plurality of microphones of the wearable device, beamforming with respect to a plurality of objects located around the wearable device;
based on the performing of the beamforming, outputting a notification corresponding to the plurality of objects through at least one of:
at least one speaker of the wearable device; or
a display module of the wearable device;
identifying movement of the wearable device in which the wearable device is rotating to face an object among the plurality of objects; and
based on the identifying of the movement, highlighting and outputting the notification corresponding to the object through at least one of the at least one speaker or the display module while maintaining the beamforming with respect to the plurality of objects.

12. The method of claim 11, wherein:
the wearable device further comprises at least one camera, and
the method further comprises, based on an image captured by the at least one camera and a sound obtained by the plurality of microphones, identifying whether the plurality of objects are located around the wearable device.

13. The method of claim 11, further comprising, in a case in which the movement of the wearable device is identified, performing beamforming by using at least one other microphone different from the at least one microphone being used for performing the beamforming.

14. The method of claim 11, further comprising controlling one or more remaining microphones other than the at least one microphone among the plurality of microphones such that the one or more remaining microphones are:
operated at low power, minimized performance, or both; or deactivated.

15. The method of claim 11, further comprising, in a case in which the movement of the wearable device is identified, outputting the notification with a volume changed according to a level of risk through the at least one speaker.

16. One or more non-transitory computer-readable storage media storing one or more computer programs including computer-executable instructions that, when executed by one or more processors of a wearable device individually or collectively, the wearable device cause the wearable device to perform operations, the operations comprising:
performing, by using at least one microphone among a plurality of microphones of the wearable device, beamforming with respect to a plurality of objects located around the wearable device;
based on the performing of the beamforming, outputting a notification corresponding to the plurality of objects through at least one of:
at least one speaker of the wearable device; or
a display module of the wearable device;
identifying movement of the wearable device in which the wearable device is rotating to face an object among the plurality of objects; and
based on the identifying of the movement, highlighting and outputting the notification corresponding to the object through at least one of the at least one speaker or the display module while maintaining the beamforming with respect to the plurality of objects.

17. The one or more non-transitory computer-readable storage media of claim 16, wherein the operations further comprising:
in a case in which the movement of the wearable device is identified, increasing a volume of the notification output through the at least one speaker or output a designated sound effect.

18. The one or more non-transitory computer-readable storage media of claim 16, wherein the operations further comprising:
in a case in which the movement of the wearable device is identified, performing beamforming by using at least one other microphone different from the at least one microphone being used for performing the beamforming.

19. The one or more non-transitory computer-readable storage media of claim 16, wherein the operations further comprising:
controlling one or more remaining microphones other than the at least one microphone among the plurality of microphones such that the one or more remaining microphones are:
operated at low power, minimized performance, or both; or
deactivated.

20. The one or more non-transitory computer-readable storage media of claim 16, wherein the operations further comprising:
in a case in which the movement of the wearable device is identified, increasing a volume of the notification output through the at least one speaker or output a designated sound effect.
